(19) United States
(12) Patent Application Publication
(10) Pub. No.: US 2004/0062421 A1
(43) Pub. Date: Apr. 1, 2004

(54) System for generating composite reports respecting personnel traffic at a personnel checkpoint

(76) Inventors: Peter Joel Jakubowski, Huntington Beach, CA (US); Yoshi Kawahara, Anaheim Hills, CA (US)

Correspondence Address: Bruce B. Brunda, STETINA BRUNDA GARRED & BRUCKER, Suite 250, 75 Enterprise, Aliso Viejo, CA, 92656, US

(21) Appl. No.: 10/231,604

(22) Filed: Aug. 30, 2002

(51) Int. Cl. G06K 9/00

(52) U.S. Cl. 382/115

(57) ABSTRACT

A system for generating composite reports respecting personnel traffic at a personnel checkpoint is provided. The system comprises a personnel identifier reading device disposed at the personnel checkpoint and operable by a personnel passing the checkpoint. The reading device responds to operation by the personnel by generating an identifier signal representative of an identifier of the personnel. A scanning device responds to the identifier signal by generating a features signal representative of at least one physiological feature of the personnel. A clocking device responds to the identifier signal by generating a time signal representative of a current time. A composite report generator is also included and is operative to generate a composite report for the identifier. The composite report comprises both the represented current time and the represented at least one physiological feature.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to devices and methodology for monitoring personnel traffic, and more particularly to a system and method for preventing collection of erroneous data respecting personnel traffic due to intentional manipulation by personnel.

Effective systems for monitoring personnel traffic are important in many applications. In particular, monitoring personnel traffic is important in management of employees paid on an hourly basis. Companies who employ per-hour wage earning employees must have systems in place to keep track of how many hours each employee has worked, so that each employee can be paid no more or less than is appropriate given the amount of time worked by the employee. The traditional solution is the ubiquitous “time clock.”

The earliest form of the time clock, still used by some companies, is used in conjunction with a card retained by the employee. When the employee arrives at work in the morning, he inserts his card into the time clock, or “clocks in.” The time clock responds by punching or printing the current time of day into or onto the card. Likewise, when the employee leaves in the evening, he again inserts his card into the time clock, or “clocks out.” The time of day is again punched into or printed onto the employee's card, thereby forming a record of the employee's presence for the day. The amount of time the employee worked can be calculated by a person with a calculator, and the employee paid accordingly.

Old fashioned time clocks of this variety suffer from various disadvantages. The cards themselves can become an inconvenience. In particular, the cards become a special nuisance when they are lost or misplaced. Since the only record of the amount of time worked by the employees is on the card, loss of the card means that no record of the employee's work is available. Also, calculation of pay must still be performed by a human if a time clock of this nature is employed.

More advanced time clocks are generally computerized. In one common form, the time clock comprises a keypad, and each employee is assigned an employee identification number. When the employee arrives in the morning, he inputs his employee number by means of the keypad and the time clock makes a digital record of the current time of day and the employee's employee number. Likewise, when the employee leaves in the evening he again inputs his employee number and the time clock makes a record of his departure. Varying models use infrared RF, proximity, holographic, barcodes, or magnetic sensors in conjunction with an identification card. Since the time clock is computerized, it can automatically and continually calculate the hours worked by the employee. In this respect, the digital time clock ensures that the number of hours worked by each employee is always a known quantity available for review or use in generating pay checks. Software, within or remote to the digital time clock can also be configured to automatically generate advanced data. For instance, the software can be configured to generate data respecting an average number of hours worked by an employee per week, or automatically distinguish between regular hours and overtime hours when reporting hours worked. Furthermore, the threat of losing data do to loss of time cards is eliminated if a computerized time clock is utilized.

However, regardless of whether the time clock uses cards or stores information digitally, it suffers from the drawback that in comparison with a situation in which a human monitor is employed. Falsification of data respecting an amount of time worked is easy. In what is probably the most common form of deception practiced by employees, one employee has another employee take the first employee's card or identification number and clocks him in and/or out. The first employee is left free to be away from work for part or all of the day in question, yet the record created by the time clock will reflect his presence for the entire day. The employee is thereby able to cheat his employer by receiving pay for hours during which he is not in fact working.

Acknowledging this, a variety of innovators have introduced devices and methods to combat the problem. In particular, the typical response is to use a biometric scanning device. The biometric scanning device scans some unique feature of the employee clocking in, and uses that feature as the form of identification instead of an employee identification number or the like. This has the advantage that falsification of data respecting time worked is practically impossible, since it is extremely difficult to fake the unique feature of the employee.

For instance, the time clock may include a fingerprint matching device. The device uses a memory in which is stored images of the fingerprints of various employees. A sensor pad is employed, onto which the employee can press his finger. The sensor pad reads the employee's fingerprint, and the fingerprint matching device matches the employee's fingerprint against the images in memory in order to determine which employee is clocking in.

In a variation on the fingerprint matching system, a hand print matching device is used. In either case, the system has certain disadvantages. First of all, employees may feel that their privacy is being violated. Because they are giving their employer unique identification information which might be used to garner further information, for instance about the employees' activities, the employees are sometimes reluctant to comply. Even when this is not the case, the employee may take offense to the simple fact that his identity is actively verified every time he comes to work or leaves. Employees are particularly likely to take offense when the system fails to recognize them and they are forced to go through the hassle of trying to get the system to work properly. Fingerprint and hand print reading devices are sensitive to environmental conditions, such as dirtiness of employees' hands. Failure of the reading process can result in unnecessary frustration and loss of time. Another problem is that many employees are reluctant to touch something which is touched on a regular basis by a large number of people. Finally, fingerprint or hand print matching is still prohibitively expensive in many applications.

An alternative to fingerprint matching is facial recognition. Facial recognition alleviates some of the above mentioned deficiencies of fingerprint and hand print recognition, but is still subject to reliability and privacy issues. Moreover, facial recognition generally requires very expensive software, making it even more costly than fingerprint or hand print recognition.

A third alternative is iris matching. In iris matching, a camera or other device is used to match the employee's iris against data in memory. Since each person's irises are unique in the same way as a fingerprint or hand print, the same principles can be used to verify employee identity. However, many employees feel nervous working with any system that they believe exposes their eyes to potential harm, and the same privacy and expense issues identified with respect to fingerprint, hand print, and facial recognition systems still arise.

In summary, the systems so far devised suffer from a variety of drawbacks, but may generally be said to be undesirably unreliable, expensive, and invasive of privacy.

### BRIEF SUMMARY OF THE INVENTION

In accordance with the present invention, a system for generating composite reports respecting personnel traffic at a personnel checkpoint is provided. The system comprises a personnel identifier reading device disposed at the personnel checkpoint and operable by a personnel passing the checkpoint. The reading device responds to operation by the personnel by generating an identifier signal representative of an identifier of the personnel, such as a personal name or unique pre-assigned number. The reading device can be, for instance, a keypad, a proximity sensor used in conjunction with a proximity reader, a magnetic strip reader used in conjunction with a magnetic strip, or an infrared, or RF receiver used in conjunction with an infrared or RF transmitter.

The system further comprises a physiological features scanning device. The scanning device responds to the identifier signal by generating a features signal representative of at least one physiological feature of the personnel, such as an appearance of the personnel's face, a finger or hand print of the personnel, or an iris pattern of the personnel.

The system further comprises a clocking device. The clocking device responds to the identifier signal by generating a time signal representative of a current time.

The system further comprises a composite report generator. It is operative to generate a composite report for the represented identifier, which comprises both the represented current time and the represented physiological features.

The composite reports are internally verifiable by comparing features signals of various traffic reports therein. They are also externally verifiable. External verification is accomplished by means of a personnel identity database having a collection of reference data representative of at least one physical feature of each of known persons. A comparator is in communication with the database and the one of the composite reports and is operative to compare the reference data of the database with the represented physiological feature to make a determination as to whether the personnel is a one of the known persons with whom the identifier is associated. The comparator can be an appropriately configured computer processor. The comparator can be a person using a monitor, which is in electrical communication of the processor who can compare the database, in order to compare the database reference data, with the scanned data.

Additional security can be achieved by locating the clocking device or a memory on which the composite reports are stored remotely to the personnel checkpoint.

A more advanced security measure employs a secure clock located remotely to the personnel checkpoint, operative to periodically update the clocking device. The secure clock may be operative to update the clocking device in response to the identifier signal, so that the clocking device is updated at each traffic occurrence.

The system may further comprise an update signal generator. The update signal generator generates an update signal representative of an elapsed time since the clocking device was updated, which is combined into the composite report and used for further verification purposes.

The composite report generator may be configured to generate composite reports only for identifiers which are on a list of suspect identifiers stored in a memory, in order to help an operator focus in on personnel who are suspected of deception.

The composite report generator may alternatively be configured to mark composite reports with warning flags if they meet certain criteria which indicate that they contain suspicious traffic records. Such criteria can include unexpected or unusual times at which traffic occurs, or unusually or unexpectedly long elapsed times between traffic records. The composite report generator can likewise be configured to mark composite reports with a warning flag if they contain traffic records in which the time signal is representative of a time proximate to that represented by the time signal of another traffic record in another composite report. In this respect, the system will function to flag composite reports having traffic records which occur close in time to traffic records of other composite reports. An alarm device of some type can be used to indicate to a personnel that his composite report is being marked with a warning flag.

A payroll device can be included which is configured to generate wage payments based upon the composite reports if the comparator determines that the personnel is the one of the known person. It can also be configured to generate partial wage payments based only on legitimate portions of the composite report.

A variety of other embodiments will be apparent to those of ordinary skill in the art.

### BRIEF DESCRIPTION OF THE DRAWINGS

These as well as other features of the present invention will become more apparent upon reference to the drawings wherein:

FIG. 1 depicts one example of a typical prior art digital time clock system in block diagram format.

FIG. 2 depicts a system for generating composite reports respecting personnel traffic at a personnel checkpoint in accordance with the present invention in block diagram format.

FIG. 3 depicts several advanced solutions to potential tampering with the system by personnel in block diagram format.

FIG. 4 illustrates a presently preferred embodiment of the present invention.

### DETAILED DESCRIPTION OF THE INVENTION

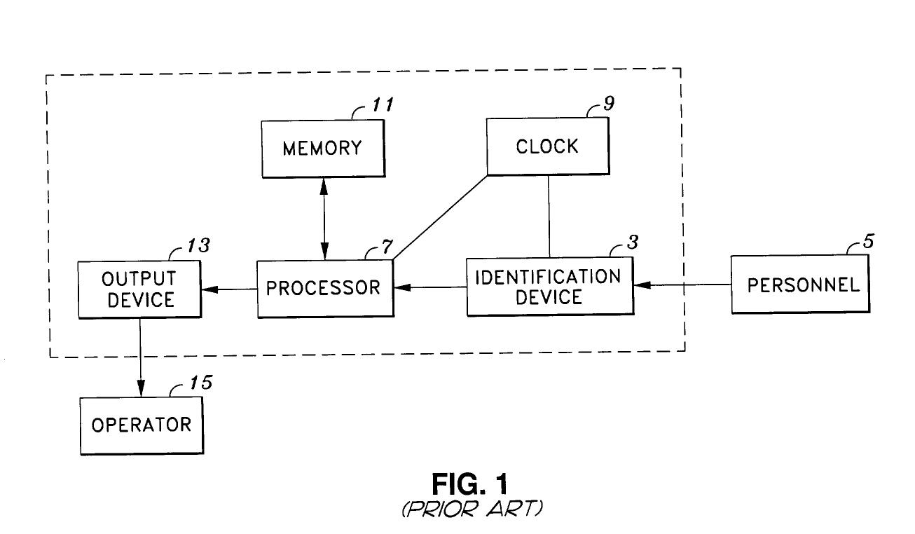

Referring now to FIG. 1, one example of a typical prior art digital time clock system is shown in block diagram format. A time clock 1 comprises an identification device 3. A personnel 5 can input identification information, such as an employee identification number, into the time clock 1 by means of an identification device 3. The identification device could be, for instance, a keypad. The keypad identification device 3 generates an identification signal representative of the identification number. The keypad identification device 3 is in electrical communication with a processor 7 and a clock 9. The clock 9 is further in electrical communication with the processor 7 and is operative to generate a time signal representative of the current time in response to the identification signal. The processor 7 is in electrical communication with a memory 11, in which it stores data respecting the time signal and the identification signal. The processor 7 can be configured to perform operations on the data stored in the memory 11, such as calculating a sum of hours worked, and may be in electrical communication with an output device 13 operative to receive data from the processor and put it into a format readable by a human operator 15.

As discussed above, this system has the disadvantage that falsification of data respecting time worked is easy. There is no guarantee that the employee number entered by means of the keypad identification device 3 is the employee number appropriately associated with the personnel 5.

Referring still to FIG. 1, this problem could be alleviated by using a finger pad in place of a key pad as the identification device 3. In this embodiment, the memory 11 additionally stores data respecting images of various employees' fingerprints. The finger pad identification device 5 is operative to scan the fingerprint of the personnel 5, and send data respecting the same to the processor 7. The processor 7 compares the data received from the fingerprint identification device 3 and the data respecting employee's fingerprints stored in the memory 11 in order to make a determination as to which employee is clocking in. Data respecting the identity of the employee and the time of day is then stored in the memory.

As discussed above, this system is effective in preventing falsification of data. However, it has certain disadvantages, among which are expensiveness, unreliability, and invasiveness of privacy.

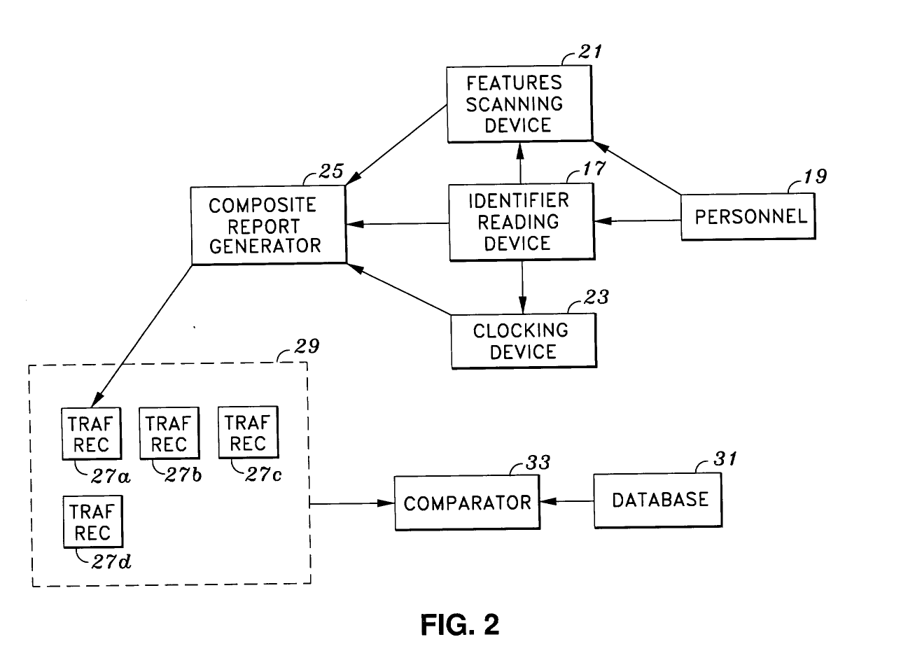

A system for generating composite reports respecting personnel traffic at a personnel checkpoint in accordance with the present invention is shown in FIG. 2. It comprises a personnel identifier reading device 17. The reading device 17 is disposed at a personnel checkpoint at which monitoring of personnel traffic is desired, and may be operated by a personnel 19 passing the checkpoint. In response to operation by the personnel, the reading device 17 generates an identifier signal representative of an identifier of the personnel. The identifier could be, for instance, a personal name of the personnel, or a unique number preassigned to the personnel. The reading device 17 can take a variety of embodiments. For instance, the reading device 17 may comprise a keypad. If so, the employee's identifier is inputable by the employee through the keypad. Alternatively, the reading device 17 could comprise a magnetic card reader. In this case, the system further comprises a magnetic card on which is stored the personnel's 19 identifier. The magnetic card will typically be retained by the personnel 19, who passes it through the reading device 17 when passing the checkpoint. A second alternative would be to use an infrared transmitter, retained by the personnel 19 and operative to transmit the identifier to an infrared receiver comprised by the reading device 17. A variety of other embodiments, e.g., incorporating bar code readers, proximity sensors, and/or RF transmitters might also be imagined by one of ordinary skill in the art.

In any case, the identifier reading device 17 is in electrical communication with a physiological features scanning device 21. The scanning device 21 is operative to generate a features signal in response to the identifier signal. The features signal is representative of at least one physiological feature of the personnel 19. In the preferred embodiment of the present invention, the at least one physiological feature comprises at least one facial feature of the personnel. Alternatively, the at least one physiological feature could comprise one or more features of fingerprints of the personnel, features of handprints of the personnel, or features of iris patterns of the personnel. A variety of other embodiments might also be imagined. The scanning device 21 comprises means as known in the art effective to scan the at least one physiological feature, whichever features are chosen.

The identifier reading device 17 is further in electrical communication with a clocking device 23. The clocking device 23 is operative to generate a time signal in response to the identifier signal. The time signal is representative of a current time.

The system further comprises a composite report generator 25. The composite report generator 25 is in electrical communication with the reading device 17, scanning device 21, and clocking device 23. It is operative to receive the identifier, features, and time signals and to generate a composite report 29 for the represented identifier. The composite report 29 comprises the represented at least one physiological feature and the represented current time. It will be recognized that the system will produce new signals each time it is operated, and that the signals will be included in the composite report each time. In this regard, it may appropriately be imagined that the composite report 29 consists of a plurality of traffic records 27a,b,c,d, each traffic record 27a,b,c,d being generated on a separate occasion on which the personnel 19 operates the reading device 17. All traffic records 27a,b,c,d associated with the same identifier together compose a one of the composite reports 29. In this regard, it will be recognized that the system may be used to generate any number of composite reports. Each composite report will correspond to a respective identifier.

It will be appreciated that the composite reports generated by the system of the present invention have characteristics rendering them internally verifiable. For instance, if two traffic reports 27a,b represent a respective arrival and departure of the personnel 19 through the checkpoint, then the features signal of each may be compared in order to make sure that they are similar. If they are not, the person who clocked in with the identifier was not actually the person who clocked out with the identifier, and some kind of deception has been practiced.

More importantly, however, the composite reports 29 generated by the system of the present invention have external verifiability characteristics. In accordance with the preferred embodiment of the invention, the system further comprises a personnel identity database 31. The database 31 comprises a collection of reference data respecting known persons cleared to pass the checkpoint. The control data is representative of a least one physiological feature of each known person. A comparator 33, such as an appropriately configured computer processor, is used in conjunction with the database 31. The comparator is in communication with both the composite reports 29 and the database 31, and is operative to compare the at least one physiological feature with the reference data, in order to make a determination as to whether the personnel is a one of the known persons with whom the represented identifier is associated. In this regard, the comparator may be configured to determine whether the personnel 19 is actually the personnel appropriately associated with the identifier represented by the identifier signal. If he is not, it will be recognized that some kind of deception has been practiced, and appropriate action can be taken accordingly. In one embodiment the comparison may be visually performed by an operator comprising the reference data with the appearance of the subject.

Modifications can be made to the basic system described above in order to make it even more difficult to falsify data. For instance, one way to practice deception upon the above system would be to change a time value, representative of the current time, used by the clocking device 23 to generate the time signal. A late personnel could set the time value of the clocking device 23 back, clock in, and then again set the time value to the correct time. In one embodiment of the invention, this is prevented by disposing the clocking device 23 remotely to the checkpoint. The clocking device 23 could be connected by means of the Internet for this purpose.

A similar problem arises if a memory (not shown) is used to store the composite reports, as in one embodiment of the present invention. If a memory is used, instead of, for instance, physically produced reports, then ambitious personnel may attempt to tamper with the memory. Accordingly, one embodiment of the present invention comprises a memory disposed remotely to the checkpoint. Like the remote clocking device 23, the remote memory can be connected by way of the Internet.

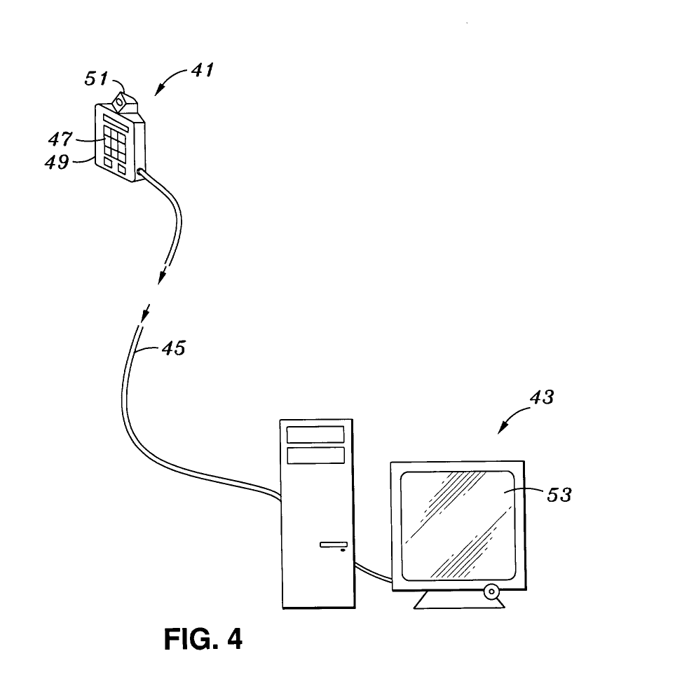

Several more advanced solutions to potential tampering with the system by personnel are shown in FIG. 3. The system may comprise a secure clock 35, disposed remotely to the checkpoint and in electrical communication with the clocking device 23. The secure clock 35 is operative to periodically update a time value of the clocking device used to generate the time signal. The secure clock 35 may further be in electrical communication with the reading device 17, and configured to update the time value in response to the identifier signal. In this case, the time value of the clocking device 23 is updated by the secure clock 35 each time the reading device 23 is operated by the personnel 19. This has the same effect as disposing the clocking device 23 remotely to the checkpoint, with the added advantage that if the system becomes isolated (due to a failure on the Internet, for instance) the clocking device 23 will still serve its function.

The system can also comprise an update signal generator 37 in electrical communication with the reading device 17, clocking device 23, and composite report generator 25. The update signal generator 37 is operative to generate an update signal in response to the identifier signal. The update signal is representative of an elapsed time since the secure clock 35 updated the time value. In this embodiment, the composite report generator 37 is further operative to combine the update signal into the traffic record of the composite report 29. In this respect, each traffic record will reflect the elapsed time since the clocking device 23 was updated at the time the traffic record is created. In practice, a separate record of updates can be kept and the elapsed time represented by the update signal compared against the separate record. If the elapsed time is not equal to the represented current time at which the traffic record was created minus the most proximate time at which the time value was updated, it is an indication of tampering with the clocking device 23.

Apart from increased security measures, additional functionality can be provided to help an operator of the system focus in on suspect personnel. For instance, the system may comprise a memory on which is stored a list of suspect identifiers. In this embodiment, the system is only operative to generate composite reports for identifiers which are on the list of suspect identifiers. Since an operator of the system may have a good idea of which personnel require his particular attention, he may update the list in order to make the system provide composite reports about only the identifiers associated with those particular personnel. Optionally, the composite report generator may be configured to automatically remove an identifier from the list of suspect identifiers if it has been on the list for at least a selected amount of time.

Alternatively, the composite report generator may be configured to mark a composite report with a warning flag if selected criteria respecting the composite report are met. The selected criteria are criteria which indicate a high likelihood that the composite report reveals some kind of deception.

For instance, the criteria might comprise that the represented current time is outside a selected range of times of day. Depending upon the application in which the system is to be used, there may be an expectation that personnel will arrive and leave within a certain time frame. Composite reports reflecting arrivals or departures outside that time frame might therefore be considered to be suspicious. This is particularly true in a situation where the composite report reflects a represented current time at which a building in which the system uses is not open to traffic.

As an alternative, the selected range of times of day can be calculated by adding a selected tolerance range to an average of represented previous current times in the same composite report. In this regard, the composite report generator is configured to determine whether the represented current time of the personnel's arrival or departure is highly unusual for that personnel. If so, it may be an indication that the traffic record is suspect, and therefore desirable to mark the composite record with a warning flag.

The aforementioned tolerance range can be made a function of a difference between maximum and minimum represented previous current times in the same composite record. In this regard, the system will function to allow a wider tolerance range for personnel for whom traffic incidents have historically been erratic than for personnel for whom traffic incidents have historically been consistent.

The same principles can be applied using elapsed times instead of current times. Specifically, the composite report generator can be configured to mark the composite report with a warning flag if the represented current time is outside a selected elapsed time range from a represented previous current time in the same composite report. Unexpectedly long work times may be an indication of suspicious entries, and it may therefore be desirable to mark composite reports having such suspicious traffic records with a warning flag.

The selected elapsed time range can be calculated by adding a selected tolerance range to a calculated average of previous elapsed times between represented previous current times in the same composite report. In this regard, the system can be configured to mark the composite report with a warning flag if the amount of time worked reflected by the composite report is unusually long for the individual in question.

The selected tolerance range can be a function of a difference between maximum and minimum previous elapsed times between represented previous current times of the same composite record. In this regard, the system will function to allow a wider tolerance range for personnel whose past amounts of elapsed time have been erratic, and a narrower tolerance range for personnel whose past amounts of elapsed time have been consistent.

In still a further embodiment, the composite report generator is configured to mark the composite report with a warning flag if the represented current time is within a selected range of a represented other current time of an other composite report. In other words, the system checks to see whether the personnel's arrival or departure is proximate in time to the arrival or departure of another personnel. Since one personnel who is helping another personnel falsify data may be expected to make a legitimate traffic record with his own identifier immediately before or after the false traffic record, close temporal proximity of different personnels' traffic records may be a sign of a suspicious traffic record. It may therefore be desirable to mark composite reports having such traffic records with a warning flag.

If an embodiment comprising a composite report generator operative to mark composite records with warning flags is utilized, it may be desirable to alert personnel to when their entries are considered suspicious. In this regard, the system may further comprise an alarm device. The alarm device is in electrical communication with the composite report generator, and is operative to generate an alarm detectable by the personnel (such as a flashing light or a sound) if the composite report generator marks the composite report with a warning flag.

It will be appreciated that the present invention goes far toward eliminating the problems described above in relation to prior art systems. With respect to expense, the present invention can be implemented in a relatively low cost embodiment employing a camera and a human comparator. Use of a human comparator is theoretically possible in conjunction with real time verification, but much more practicable in conjunction with composite reports. The composite reports can be reviewed at leisure, and moreover can be reviewed selectively as described above.

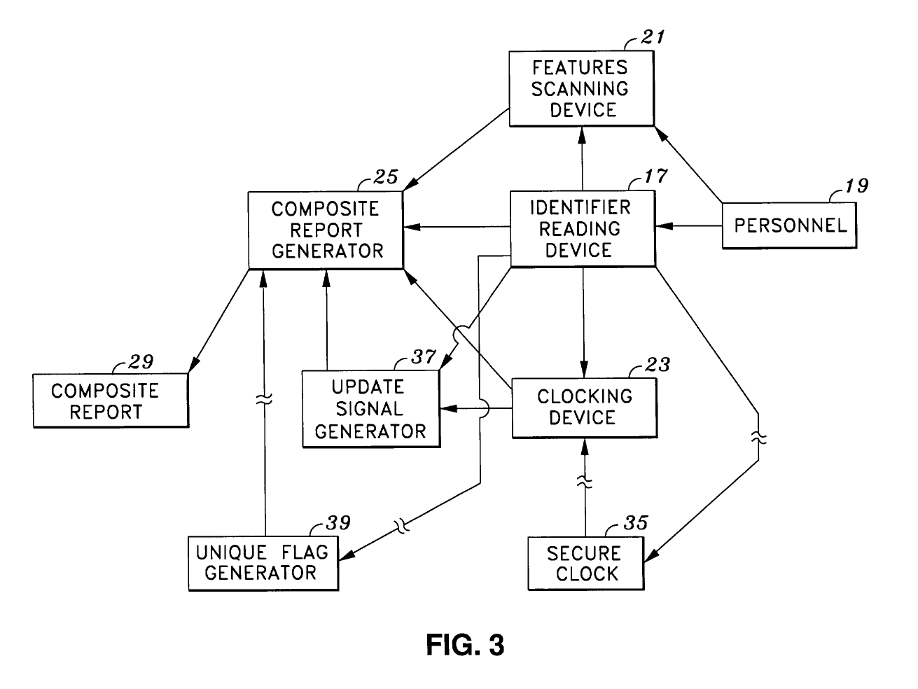

A presently preferred embodiment of the present invention is illustrated in FIG. 4. The system comprises a time clock 41 disposed at the personnel checkpoint and a computer 43 disposed elsewhere. The two are connected by a cable 45. The time clock 41 has a housing 49 on which is disposed a keypad 47. A personnel passing the checkpoint can input his identifier on the keypad 47. In response, a wide angle camera 51 disposed on the top of the housing 49 in such a way that it points at the face of a personnel operating the time clock 41 takes a digital photograph of the personnel. The picture is sent through the cable 45 to the computer 43, which has an internal clock, processor, and hard drive. The computer 43 uses its internal clock to generate a signal representative of the current time, and generates a composite report for the identifier comprising the time and features signals. The contents of the file can be operated upon by the processor. Accordingly, the computer 43 may comprise software and hardware operative to perform any of the various optional functions described above, such as marking composite records with warning flags. The files produced by the computer 43 can be displayed in human readable format on a monitor 53 comprised by the computer, and verification thereof performed accordingly.

With respect to reliability, the system is operable to produce a composite report regardless of whether the features signal generated is a particularly effective or ineffective representation of the at least one physiological feature of the personnel. Poor operation of the scanning device or adverse circumstances will therefore not result in inability of personnel to pass the checkpoint. In the case that features signals of various traffic records in a composite report for a single identifier are found to be repeatedly bad, human intuition can be used to determine what the problem is and appropriate action taken.

With respect to invasion of privacy, it will be appreciated that there are embodiments of the present invention constituting a monitoring system which can appropriately be described as passive. Such embodiments do not actively investigate the identity of personnel passing the checkpoint, but instead accumulate data which can be reviewed only upon occurrence of facts giving rise to suspicion directed toward the personnel in question. Moreover, as described above, the present invention renders the use of cameras for verification purposes both inexpensive and reliable. Since people are by and large used to being monitored passively by cameras, for instance at banks, they have grown to no longer regard this as an invasion of their privacy. Moreover, cameras can be disposed discretely at the checkpoint, unlike finger pads or iris scanners.

The system can gain further functionality from the addition of further elements. In a preferred embodiment of the present invention which employs a comparator as described above, the system further comprises a payroll device in communication with the composite report generator and the comparator. The payroll device is operative to generate a wage payment from the composite report if the comparator determines that the personnel is the one of the known personnel. In this regard, the comparator functions to automatically check the represented physiological features against the represented identifier for each traffic record to make sure that the same match properly, and if they do, the device generates a wage payment for that person because their report is considered legitimate.

The system may further be configured to generate wage payments even if the comparator detects some kind of deception. In this case, amounts of the wage payments generated are based upon represented other current times in the composite report. The other current times are ones for which the comparator determined that the personnel was in fact the one of the known personnel. In other words, the payroll device makes payments based only upon legitimate traffic records, and not upon illegitimate traffic records.

It is understood that the above describes preferred embodiments of the invention only, and that further embodiments will be apparent to those of ordinary skill in the art. Such embodiments are intended to be within the scope and spirit of the present invention.

I claim:

1. A system for generating composite reports useful for confirming identity and check-in time of personnel at a personnel checkpoint, the system comprising:
a. a personnel identifier reading device disposed at the personnel checkpoint, operative to generate an identifier signal in response to operation of the reading device by a personnel passing the checkpoint, the identifier signal being representative of an identifier of the personnel;
b. a physiological features scanning device in electrical communication with the reading device, operative to generate a features signal in response to the identifier signal, the features signal being representative of at least one identifying physiological feature of the personnel;
c. a clocking device in electrical communication with the reading device, operative to generate a time signal in response to the identifier signal, the time signal being representative of a current time; and
d. a composite report generator in electrical communication with the reading device, scanning device, and clocking device, the report generator being operative to receive the identifier, features, and time signals and to generate a composite report for the represented identifier, the composite report comprising the represented at least one physiological feature and the represented current time.

2. The system of claim 1, wherein the identifier is a personal name of the personnel.

3. The system of claim 1, wherein the identifier is a unique number preassigned to the personnel.

4. The system of claim 1, wherein the reading device comprises a keypad and the identifier is inputable through the keypad by the personnel.

5. The system of claim 1, further comprising a magnetic card carried by the personnel, the card being operative to store the identifier, and wherein the reading device is a magnetic card reader operative to read the identifier from the magnetic card.

6. The system of claim 1, further comprising an infrared transmitter carried by the personnel, the transmitter being operative to transmit the identifier, and wherein the reading device is an infrared receiver operative to receive the identifier transmitted by the transmitter.

7. The system of claim 1, wherein the at least one physiological feature comprises at least one facial feature of the personnel.

8. The system of claim 1, wherein the at least one physiological feature comprises at least one fingerprint feature of the personnel.

9. The system of claim 1, wherein the at least one physiological feature comprises at least one hand print feature of the personnel.

10. The system of claim 1, wherein the at least one physiological feature comprises at least one iris pattern feature of the personnel.

11. The system of claim 1, further comprising:
a. a personnel identity database comprising a collection of reference data representative of at least one physiological feature of each of known personnel cleared to pass the checkpoint; and
b. a comparator in communication with the database and the composite report, operative to compare the represented at least one physiological feature with the reference data, to determine whether the personnel is a one of the known personnel associated with the represented identifier.

12. The system of claim 1, wherein the clocking device is disposed remotely from the personnel checkpoint.

13. The system of claim 1, further comprising a secure clock disposed remotely from the personnel checkpoint and in electrical communication with the clocking device, the secure clock being operative to periodically update the clocking device.

14. The system of claim 1, further comprising a memory, wherein the composite report is stored in the memory.

15. The system of claim 14, wherein the memory is disposed remotely from the personnel checkpoint.

16. A system for selectively generating composite reports useful for confirming identity and check-in time of personnel at a personnel checkpoint, the system comprising:
a. a memory operative to store a list of suspect personnel identifiers;
b. a personnel identifier reading device in communication with the memory and disposed at the personnel checkpoint, the reading device being operable by a personnel passing the checkpoint to generate an identifier signal representative of an identifier of the personnel if the identifier is one of the suspect identifiers.
b. a physiological features scanning device in electrical communication with the reading device, operative to generate a features signal in response to the identifier signal, the features signal being representative of at least one identifying physiological feature of the personnel;
c. a clocking device in electrical communication with the reading device, operative to generate a time signal in response to the identifier signal, the time signal being representative of a current time; and
d. a composite report generator in electrical communication with the reading device, scanning device, and clocking device, the report generator being operative to receive the identifier, features, and time signals and to generate a composite report for the represented identifier, the composite report comprising the represented at least one physiological feature and the represented current time.

17. The system of claim 1, wherein the composite report generator is further operative to mark the composite report with a warning flag if selected criteria respecting the composite report are met.

18. The system of claim 17, wherein the selected criteria comprise that the represented current time is outside a selected range of times of day.

19. The system of claim 18, wherein the selected range of times of day is a calculated by adding a selected tolerance range to an average of represented previous current times in the composite record.

20. The system of claim 19, wherein the selected tolerance range is a function of a difference between maximum and minimum represented previous current times in the composite report.

21. The system of claim 17, wherein the selected criteria comprise that the represented current time is outside a selected elapsed time range from a represented previous current time in the composite report.

22. The system of claim 21, wherein the selected elapsed time range is calculated by adding a selected tolerance range to a calculated average of previous elapsed times between represented previous current times in the composite record.

23. The system of claim 22, wherein the selected tolerance range is a function of a difference between maximum and minimum previous elapsed times between represented previous current times in the composite report.

24. The system of claim 17, wherein the selected criteria comprise that the represented current time is within a selected range of a represented other current time of an other composite report for a different identifier.

25. The system of claim 17, further comprising an alarm device in electrical communication with the composite report generator, operative to generate an alarm detectable by the personnel if the composite report generator marks the composite report with the warning flag.

26. A device for generating composite reports useful for confirming identity and check-in time of personnel at a personnel checkpoint, comprising:
a. a time clock input port connectable to a time clock, the time clock input port being operative to receive a time signal representative of a current time from the time clock, and further operative to receive an identifier signal from the time clock, the identifier signal being representative of an identifier of a personnel operating the time clock;
b. a features input port connectable to a physiological feature scanning device, the features input port being operative to receive a features signal from the scanning device, the features signal being representative of at least one identifying physiological feature of the personnel;
c. a processor in communication with the time clock input port and features input port, the processor being operative to receive the time, identifier, and features signals and to generate a composite report for the represented identifier, the composite report comprising the represented at least one physiological feature and the represented current time; and
d. an output port in communication with the processor and connectable to an external device, the output port being operative to transmit the composite report to the external device.

27. The system of claim 11, further comprising a payroll device in communication with the composite report generator and the comparator, the payroll device being operative to generate a wage payment from the composite report if the comparator determines that the personnel is the one of the known personnel.

28. The system of claim 27, wherein the payroll device is further operative to generate a partial wage payment from the composite report if the comparator determines that the personnel is not the one of the known personnel, an amount of the partial wage payment being based upon represented other current times in the composite report, the other current times being ones for which the comparator determined that the personnel was the one of the known personnel.
